(19) United States
(12) Patent Application Publication
(10) Pub. No.: US 2011/0242328 A1
(43) Pub. Date: Oct. 6, 2011

(54) IR-BASED MULTISPECTRAL DISTURBED GROUND DETECTION

(75) Inventors: DAVID TWEDE, ORLANDO, FL (US); SCOTT ROBERSON, OCOEE, FL (US)

(73) Assignee: LOCKHEED MARTIN CORPORATION, BETHESDA, MD (US)

(21) Appl. No.: 13/080,419

(22) Filed: Apr. 5, 2011

Related U.S. Application Data
(60) Provisional application No. 61/320,885, filed on Apr. 5, 2010.

(51) Int. Cl. H04N 5/33

(52) U.S. Cl. 348/164; 348/E05.09

(57) ABSTRACT

A multispectral imaging system identifies disturbed ground regions in an interrogation area and includes an image sensor. The image sensor includes a photodetector array, a filter that transmits a non-near infrared (non-NIR) reference band and NIR including band from diffusely scattered light to the photodetector array. The 2-D photodetector array generates separately detected first non-NIR reference band data and NIR comprising band data. A processor for data processing is coupled to the photodetector array to receive the non-NIR reference band data and NIR band data. The data processing includes utilizing both the NIR band data and the non-NIR reference band data to generate processed image data that can be used to identify disturbed ground regions within the interrogation region.

### CROSS REFERENCE TO RELATED APPLICATIONS

This application claims the benefit of Provisional Application Ser. No. 61/320,885 entitled “IR-BASED MULTISPECTRAL DISTURBED GROUND DETECTION”, filed Apr. 5, 2010, which is herein incorporated by reference in its entirety.

### FIELD

Disclosed embodiments relate to multispectral disturbed ground detection.

### BACKGROUND

Deployed troops can be endangered by improvised explosive devices (LEDs). Most IEDs have some element (ordnance, pressure plates, wires, etc.) buried in the ground. The current state of the art (SOA) detection systems for sensing disturbed ground include laser spectroscopy and thermal (IR) spectral systems. For example, published work includes disturbed soil detection using a single band in a portion of the IR, such as the short-wave IR (SWIR), mid-wave IR (MWIR), or long-wave IR (LWIR). The best contrast (i.e. vs. the background) is generally found in the UV-NIR and LWIR, while the variance in the SWIR and MWIR is generally too high for practical use. Such systems can generally provide both day and night operation. However, these systems are generally expensive, are large in size, and are susceptible to damage in harsh environments.

### SUMMARY

Disclosed embodiments are based on the discovery that reflection data from the separate detection of a near infrared (NIR) comprising band and one or more reference bands outside the NIR (non-IR reference band) can be used to differentiate disturbed ground from undisturbed ground for a variety of different backgrounds (e.g., soil types, vegetation, tire tracks). Identified disturbed ground regions can evidence buried ordnances such as IEDs or landmines, which allows avoidance actions to be undertaken, including mine sweeping. The non-NIR reference band data can provide discrimination relative to the background, while two or more non-IR reference bands may be used for certain diverse backgrounds. As used herein, “ground” is broadly defined to include surfaces of the earth, whether comprising small particles (e.g., sand) or large particles (e.g., gravel), whether or not including vegetation thereon. As defined herein the full NIR band spans from about 700 nm to about 1,300 nm.

The phenomenology rule discovered upon which disclosed embodiments are based is disturbed ground generally diffusely scatters substantially more NIR light back to the viewer (e.g., a camera) than NIR light from undisturbed ground regions. One exception to this rule is when the light source is forward (e.g., the sun being in the observer's eyes or detector's “eyes”), in which case highly packed undisturbed areas can become specular reflecting to light including NIR light. The addition of a NIR polarizer where the polarization axis is oriented perpendicular to the specular reflected polarization axis can aid in maintaining the above rule in this particular case by removing the specular reflectance including specular reflectance in the NIR.

One disclosed embodiment comprises a manual multispectral imaging system for identifying disturbed ground in which an image is displayed on a suitable video display to a user who uses the image to determine the presence of disturbed ground therein. A processor for data processing separately receives the non-NIR reference band data and NIR band data, and utilizes both the NIR band data to the non-NIR reference band data to generate processed image data. An image is displayed from processed image data. The image displayed is generally a color image. Any color can generally be assigned in the processing to the NIR comprising band data to highlight the presence of disturbed regions in the image.

Disclosed embodiments also include automatic disturbed ground multispectral imaging systems for automatically identifying disturbed ground regions. Automatic disturbed ground multispectral imaging systems include an image sensor and processor having associated memory that separately receives the non-NIR reference band data and NIR band data, utilizes both the NIR band data to the non-NIR reference band data to generate processed image data, and uses reference measures stored in the memory to automatically determine whether the processed image data includes disturbed ground therein. The automatic disturbed ground detection system can include an alarm that is activated if disturbed ground is detected.

Disclosed disturbed ground detection imaging systems can further include scanners, such as mechanical scanners. In this embodiment the scanner can be mechanically coupled to the multispectral imaging system to scan the image sensor across a plurality of different surface portions within a region of interest.

### BRIEF DESCRIPTION OF THE DRAWINGS

FIG. 1 is depiction of an example NIR-based manual multispectral imaging system that renders a displayed image for the user to determine the presence of disturbed ground in an interrogation region, according to a disclosed embodiment.

FIG. 2 is block diagram depiction of an example NIR-based automatic multispectral imaging system that includes a processor including associated memory that automatically determines the presence of disturbed ground in an interrogation region, according to a disclosed embodiment.

FIG. 3 is a depiction of an example automatic scanning multispectral imaging system that comprises the automatic multispectral imaging system shown in FIG. 2 together with at least one mechanical scanner shown as a robotic arm mechanically coupled to the imaging system for scanning the imaging system across a plurality of different surface portions within the interrogation region, according to a disclosed embodiment.

FIGS. 4A-J provide the responses of example filter combinations used to obtain color images of an interrogated area using a example disclosed manual multispectral imaging system that was used for identifying disturbed ground regions, according to various disclosed embodiments.

### DETAILED DESCRIPTION

Disclosed embodiments are described with reference to the attached figures, wherein like reference numerals, are used throughout the figures to designate similar or equivalent elements. The figures are not drawn to scale and they are provided merely to illustrate aspects disclosed herein. Several disclosed aspects are described below with reference to example applications for illustration. It should be understood that numerous specific details, relationships, and methods are set forth to provide a full understanding of the embodiments disclosed herein. One having ordinary skill in the relevant art, however, will readily recognize that the disclosed embodiments can be practiced without one or more of the specific details or with other methods. In other instances, well-known structures or operations are not shown in detail to avoid obscuring aspects disclosed herein. Disclosed embodiments are not limited by the illustrated ordering of acts or events, as some acts may occur in different orders and/or concurrently with other acts or events. Furthermore, not all illustrated acts or events are required to implement a methodology in accordance with this Disclosure.

One embodiment disclosed herein comprises a multispectral imaging system for identifying disturbed ground regions within an interrogation area. The imaging system comprises an image sensor for receiving diffusely scattered light from the interrogation area, wherein the image sensor comprises a 2-D photodetector array that comprises a plurality of photodetector pixels that include pixels that are sensitive to the NIR band and pixels sensitive to at least one non-NIR band, or includes pixels that are sensitive to both such bands. A filter that transmits a first non-NIR comprising reference band is optically coupled to (e.g., disposed on) photodetector pixels in the photodetector array that are sensitive to light in the non-NIR comprising reference band to generate first reference band data. A filter that transmits a NIR comprising band is optically coupled to photodetector pixels in the photodetector array that are sensitive to NIR light to generate NIR comprising band data.

In one embodiment the filter used comprises a single fixed band pass filter that transmits both the non-NIR comprising reference band and the NIR comprising band. In this embodiment, the 2-D photodetector array can comprise a multi-band detector array that includes pixels that detect both the non-NIR comprising reference band and the NIR comprising band, along with switching electronics that can switch between detection of the non-NIR comprising reference band and the NIR comprising band.

Disclosed multispectral imaging systems can be compact systems that provide handheld capability. Such systems can be battery powered. Handheld capability provides the ability to walk while imaging with disclosed multispectral imaging systems to allow real-time identification of disturbed ground which may include buried ordnances such as IEDs or landmines, which allows avoidance actions to be undertaken. Operation can be extended to night operation by providing a camera light source or by a suitable photodetector that can operate at night or other low light conditions, such as based on electron multiplied CCD technology.

Image sensors for disclosed imaging systems can be embodied as any structure that allows that separate detection of received NIR comprising band light (e.g., 700 to 1,000 nm) and non-NIR comprising band light. Example structures include for separate detection include spinning filter wheels, custom Bayer filter patterns (e.g., 3 to 4 filters in 2×2 arrays), or a full spectrum (e.g., conventional color camera having its hot filter removed) systems with an external filter. Moreover, as noted above, in one embodiment the filter comprises a single fixed band pass filter that transmits both the non-NIR comprising reference band and the NIR comprising band that is combined with a multi-band 2-D detector array that includes pixels that detect both the non-NIR comprising reference band and the NIR comprising band, along with switching electronics for band switching to allow separate band detection.

A processor for data processing is coupled to outputs of the 2-D photodetector array that separately receives the non-IR reference band data and NIR comprising band data. The processor utilizes both the NIR band data and the non-NIR band data to generate processed image data. The data processing can comprise comparing the NIR band data and the non-NIR band data, such as rationing the intensity of the reflectivities between the NIR and reference band(s). The processed image data can be multi-band image data that can be used to generate a displayed image for a user to identify disturbed ground regions within the interrogation area, or the processed image data can be used by a processor to automatically identify disturbed ground regions within the interrogation area. To provide a displayed image, the data processing can comprise data normalization, color orthogonalization and RGB assignment of the first non-NIR comprising reference band data and the NIR comprising band data.

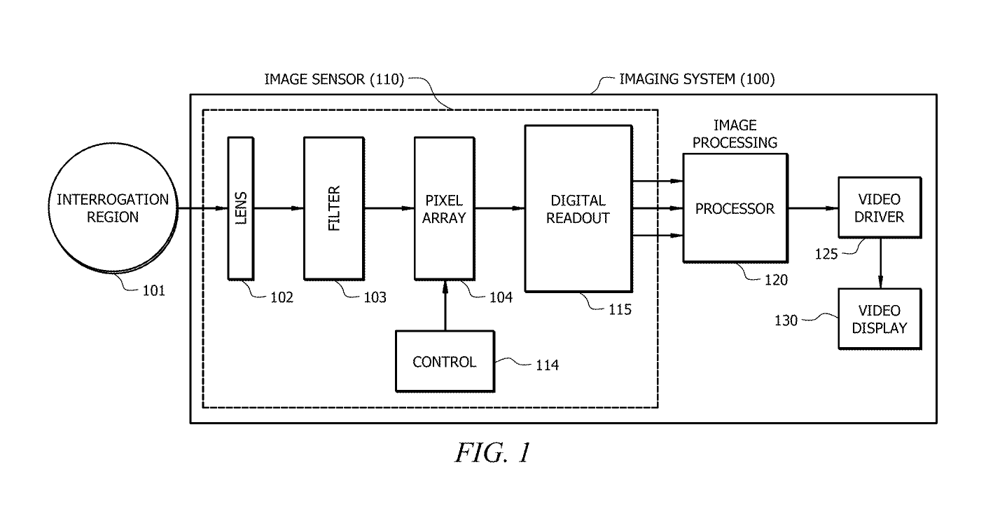

FIG. 1 is block diagram depiction of an example manual multispectral imaging system 100 that renders a displayed image for a user to determine the presence of disturbed ground in an interrogation region 101, according to a disclosed embodiment. System 100 comprises an image sensor 110 that comprises a lens 102 that provides an aperture for system 100 and focuses incoming light, so that system 100 operates on diffusely scattered light emanating from interrogation region 101 collected by lens 102 and shown sensed by a single common pixel array 104 that comprises a plurality of photodetector elements in a 2-D array. System 100 is generally a passive imaging system as it does not require a separate light source.

A filter 103 is shown that is optically aligned and matched (i.e. has about the same size) with respective ones of the plurality photodetector pixels in pixel array 104. The filter 103 can be a band reject, band pass, low pass, or long pass, and can be embodied as a polarizing filter. As noted above, when the light source is a forward light source, such as reflected from a specular reflecting surface, a broadband (e.g., visible +NIR or NIR) polarizing filter can included to ensure the disturbed ground region generally reflects more NIR light back to the image sensor 110 than undisturbed ground regions. Although shown as an internal filter, filter 103 can be an external filter (i.e., positioned in front of lens 102).

Pixel array 104 comprises a plurality photodetector pixels in a 2-D array for transducing received color band signals, NIR band signals and optionally UV signals into electrical signals. The pixel array 104 can comprise, for example, a plurality of CCD elements, or a plurality of CMOS sensing elements such as photodiodes, phototransistors, or avalanche diodes. Night (or low light) operation can be provided by pixel array comprising electron multiplied CCD, or a cameral light source (not shown).

The filter array 103 shown can comprise a plurality of filter elements, including an NIR or NIR/red band pass and at least one other reference bandpass that excludes NIR. As described above, respective ones of the filter elements of filter 103 are optically aligned and substantially matched (i.e. have about the same size) with respective ones of the photodetector pixels in pixel array 104.

For example, UV/blue and green/orange bands are example non-NIR bands that can act as a reference band in which the disturbed reflectance is very close to the undisturbed reflectance (except in the specular case). Another source of false-positives can be vegetation, which is reflective somewhat in the both the green and in the NIR. Proper choice of a reference band (green or green+UV-blue or red-NIR) can provide discrimination between vegetation and disturbed regions.

Associated with pixel array 104 is a control block 114 that comprises control electronics. As known in the art, the control block 114 generates the control signals (e.g., control voltages) to control the operation of the pixel array 104. When the pixel array 104 comprises CMOS elements, control block 114 can generally be formed on the same substrate having a semiconductor surface (i.e. a silicon chip) that generates the on-chip control signals (e.g., voltage pulses) used to control the operation of the pixel array 104.

The voltage outputs provided by pixel array 104 are read out by the digital read out 115 shown in FIG. 1 that generally comprises an analog to digital (A/D) converter. Pixel array 104 provides a plurality of outputs.

Processor 120, such as a digital signal processor or microcomputer, is coupled to receive and process the plurality of electrical signals provided by digital read out 115. The processor 120 provides data processing (i.e., image processing) as described herein. An output of processor 120 is coupled to a video driver 125 which is coupled to a video display 130, such as a video screen (e.g., color monitor), that provides a viewable color image.

Multispectral imaging system 100 can be integrated with glasses or goggles, such as a head mounted display (HMD). In one embodiment an augmented reality HMD uses image data from processor 120 to form computer generated image (CGI) data which is registered and combined with a real world view for the user. In this embodiment, images from the CGI data displayed on the display screen in the field of view of a soldier can alert the soldier to buried ordnances such as IEDs or landmines, which can allow soldiers to avoid the buried ordnances, and also alert others to initiate clearing the ordnance(s).

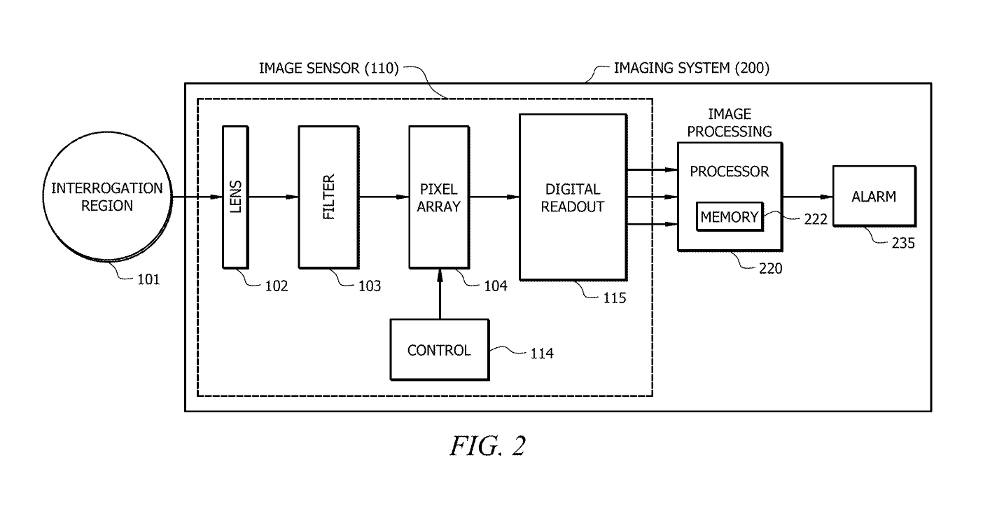

FIG. 2 is block diagram depiction of an example automatic multispectral imaging system 200 that includes a processor 220 including associated memory 222 that automatically determines the presence of disturbed ground in an interrogation region 101, according to a disclosed embodiment. Processor 220 identifies disturbed ground regions in the interrogation region 101 using one or more of the following stored reference measures: NIR signal level thresholds (e.g., relative to undisturbed ground or non-NIR signals) or ranges, statistical measures (e.g., covariance, classification) on counts from the photodetector array, and shapes of detected patterns (e.g., tire tracks or foot prints).

The processor 220 includes data processing software for utilizing (e.g, comparing, such as ratioing) both the NIR band data and non-NIR reference band data to generate processed image data, and uses the reference measure(s) to automatically identify disturbed ground regions within the interrogation area based on the processed image data. The automatic disturbed ground detection system 200 is shown including an alarm 235 (e.g., audible or blinking light) that can be activated if processor 220 detects disturbed ground in interrogation region 101.

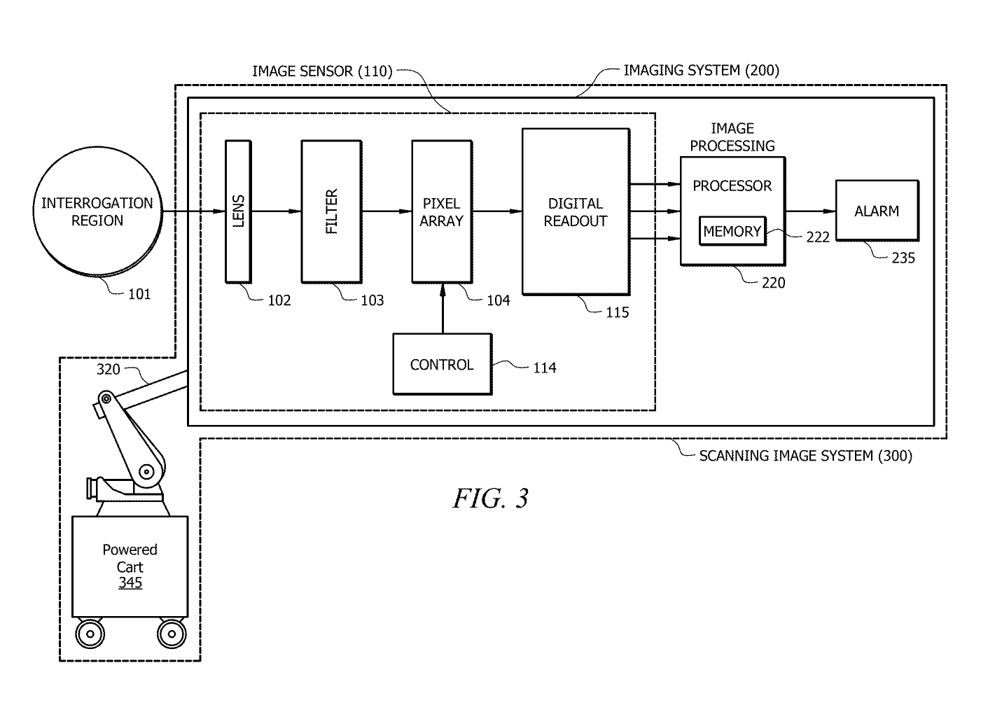

FIG. 3 is a depiction of an example automatic scanning multispectral imaging system 300 that comprises the automatic multispectral imaging system 200 shown in FIG. 2 together with at least one mechanical scanner 320 shown as a robotic arm 320 mechanically coupled to the imaging system 200 for scanning the imaging system 200 across a plurality of different surface portions within the interrogation region 101, according to a disclosed embodiment. Automatic scanning multispectral imaging system 300 is shown including a powered cart 345, such as a battery powered cart, where the robotic arm 320 is affixed to the powered cart 345. The automatic scanning multispectral imaging system 300 can be affixed, for example, to a vehicle, such as a tank or jeep, unmanned aerial or unmanned ground vehicle (i.e., a drone). As described above, the image sensor 110 for systems 100 and 200 can comprise a full spectrum digital video camera having at least one filter thereon. However, as disclosed above, in other embodiments, the image sensor can be provided by a custom Bayer element having two (2) or more different filters, or comprise separate elements (i.e. split sensor designs, such as using a spinning filter wheel).

Thus, multispectral imaging systems disclosed herein can include custom optics (band pass filters), but can also be based on commercial off-the-shelf (COTS) full spectrum digital cameras modified to have the hot mirror removed along with custom filters, and thus can be low-cost, and compact. Most digital imaging sensors (e.g. CCD or CMOS photodiodes) are sensitive from about 350 nm to 1,000 nm, thus sensing the NIR from about 700 nm to about 1,000 nm.

An off-the-shelf digital camera contains an infrared hot mirror filter that blocks most of the IR and a bit of the UV that would otherwise be detected by the photodetector, narrowing the accepted range to the visible only, from about 400 nm to 700 nm. Replacing the hot mirror or infrared blocking filter with an infrared pass or a wide spectrally transmitting filter allows the off-the-shelf digital camera to detect the wider spectrum light at greater sensitivity. Without the hot-mirror, the red, green and blue (RGB, or cyan, yellow and magenta) colored micro-filters placed over the photodetector elements pass can pass varying amounts of UV in the blue filter windows and NIR (700 to 1,000 nm) primarily in the red filter windows, and somewhat less in the green and blue filter windows. Alternatively, NIR and non-NIR band data diffusely scattered from an interrogation region can be collected with a custom camera or other optical sensor that lacks a hot-mirror or its equivalent.

As described above, data processing is used to utilize both the NIR comprising band data and reference band data to generate processed image data. For the manual multispectral imaging system embodiments, data processing generally comprises data normalization, color orthogonalization and RGB assignment of the respective bands of data to generate a displayed image to a user.

There are several data normalization options. For example, in one option the respective bands are ratioed. Ratioing is multiplying by a fraction (f) the intensity values to reduce or increase one band (b) relative to the other band(s). The formula is of the form:

Bands(bi=1 . . . 3)={(f1*b1), (f2*b2), (f3*b3)} where the f1,f2,f3 fractions are weighted by the algorithm and normalized so their sum is unity (f1+f2+f3=1). Bands ratios can be of 1:1 normalization, 2:1, 3:1 . . . 10:1 range. After band assignment, the output can be an image with three RGB bands produced by weighting the original bands.

A second normalization option mixes channels to generate a gray image.

A single-band gray image can be generated using the following formula:

Gray=f1*b1+f2*b2+f3*b3+ . . . . In this normalization option the fractions f are normalized so their sum is unity. For example, if b1 is Red/NIR, b2 is blue and b3 is green, an image can be formed using 70% Red/NIR, 15% blue, and 15% green.

Color orthogonalization is known image processing that involves decorrelating the respective band data. RGB assignment of the respective bands is generally arbitrary. Thus, although the data described below generally assigns the NIR comprising band to red, such an assignment is arbitrary.

### Examples

Disclosed embodiments are further illustrated by the following specific Examples, which should not be construed as limiting the scope or content of this Disclosure in any way. For example, although all Examples below relate to manual multispectral imaging system embodiments that render displayed images for the user to determine the presence of disturbed ground in an interrogation region, as disclosed above, disclosed embodiments include automatic multispectral imaging systems that include a processor including associated memory that automatically determines the presence of disturbed ground in an interrogation region without the need for a rendered image.

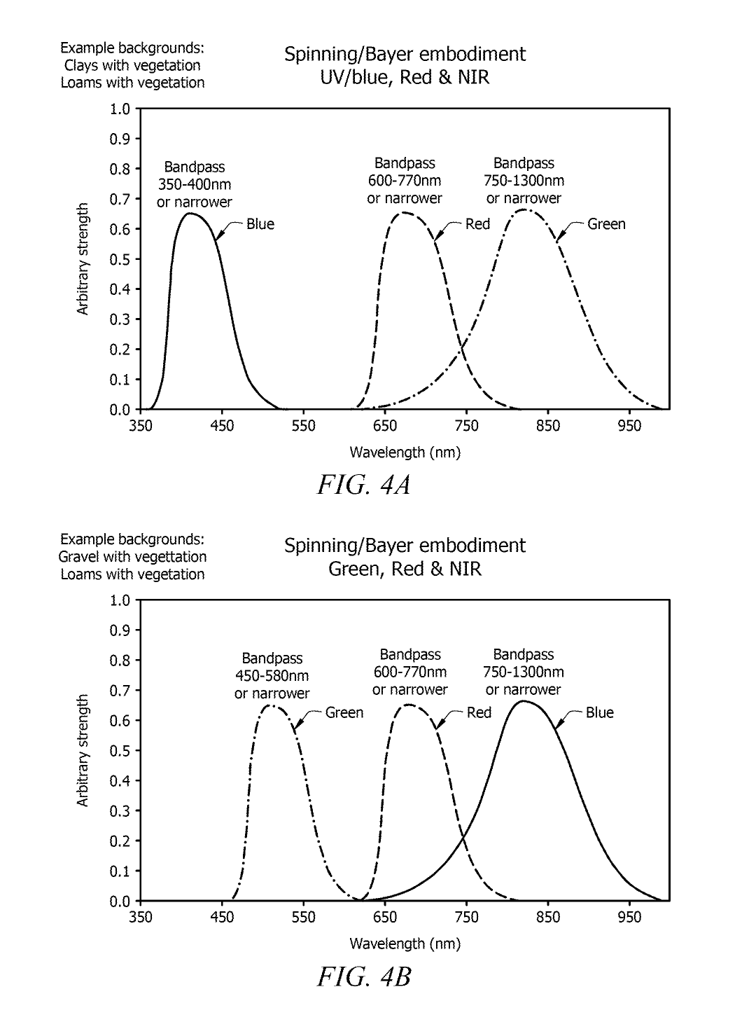

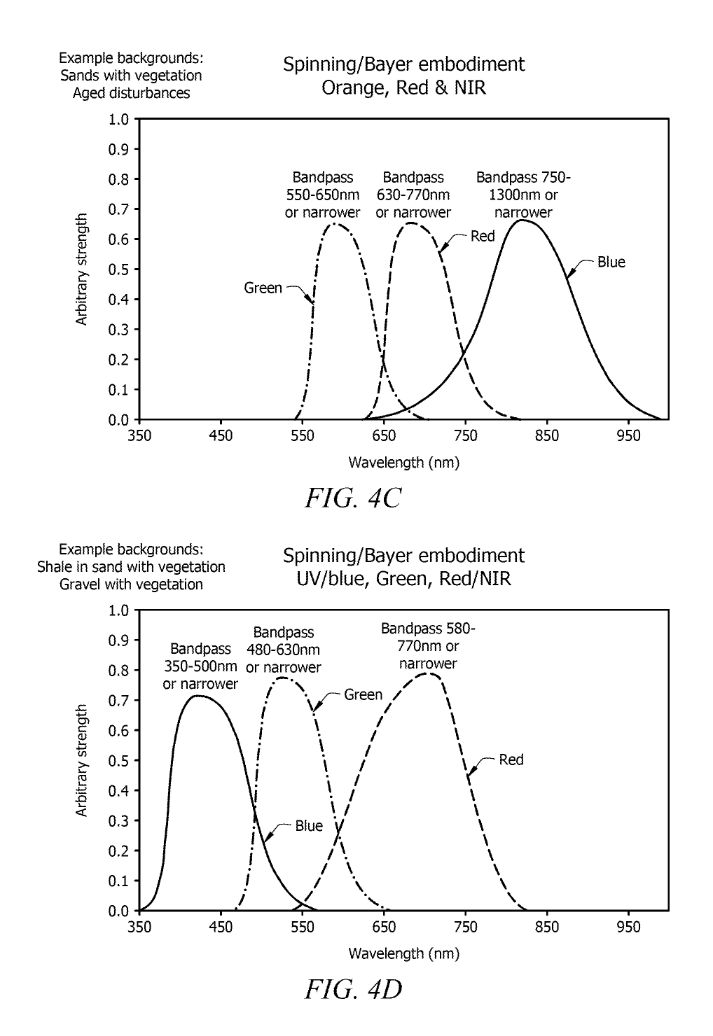

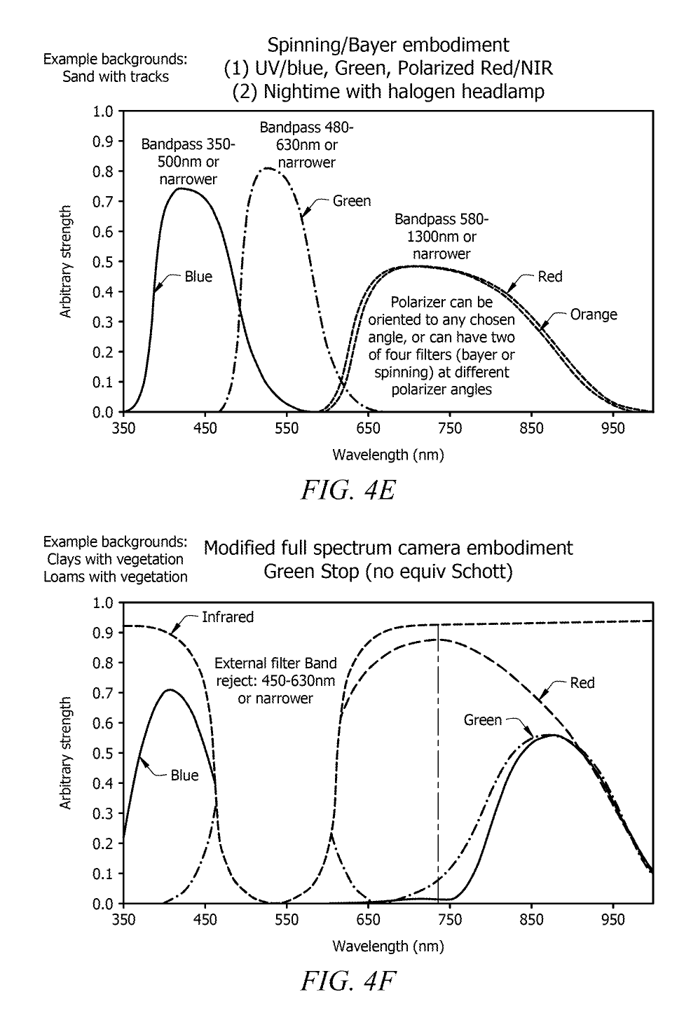

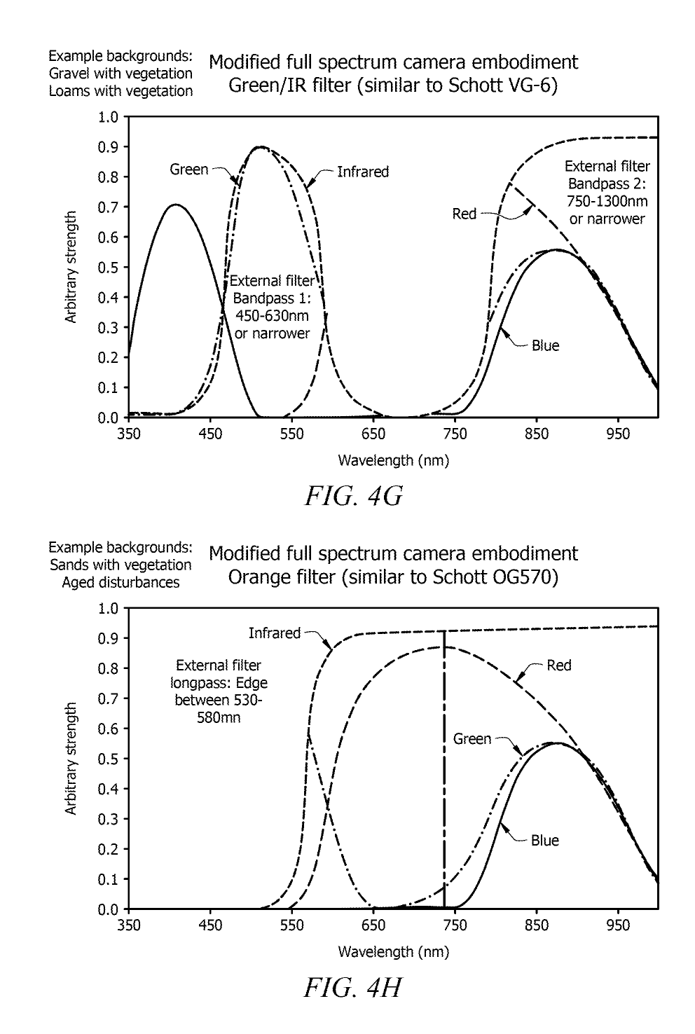

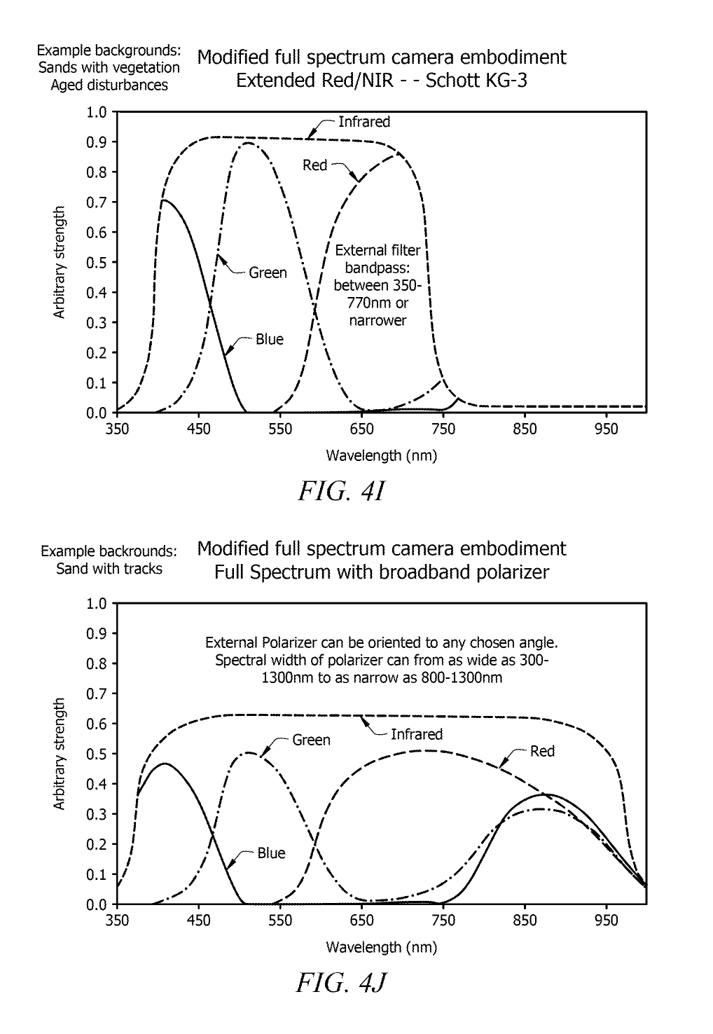

FIG. 4A-J provide the responses of example filter combinations used to obtain color images of an interrogated area using a example disclosed manual multispectral imaging system for identifying disturbed ground regions, according to various disclosed embodiments. The color indications (e.g., red, green, blue) within the plots in these FIGS. reflect the arbitrary RGB assignment of the respective bands of data used to generate the displayed images actually used.

FIG. 4A shows three (3) bandpass ranges used in an imaging system comprising a spinning filter wheel/Bayer embodiment with a first NIR/red bandpass from about 750 nm to 1300 nm, and second NIR/red bandpass from about 600 nm to 770 nm and a 350 to 450 nm (UV/blue) reference bandpass. The band color assignments used for the rendered image for the first to third bandpasses were to green, red and blue, respectively, so that disturbed ground regions appeared red/green (yellow) in the image. The processing used was decorrelation stretching. This embodiment has found to be helpful for identifying disturbed ground from clays with vegetation and loams with vegetation backgrounds.

FIG. 4B shows bandpass ranges used in an example disclosed manual imaging system comprising a spinning filter wheel/Bayer embodiment with a first NIR/red bandpass from about 750 nm to 1300 nm, and second NIR/red bandpass from about 600 to 770 nm and a third reference bandpass from about 450 to 580 nm. Band color assignments used for the first to third bandpasses were to blue, red and green, so that disturbed ground regions appeared red/green (yellow) in the image. The processing used was normalization of bands to emphasize the red and green and deemphasize the blue. This embodiment has found to be helpful for identifying disturbed ground from gravel with vegetation and loams with vegetation backgrounds.

FIG. 4C shows bandpass ranges used in an example disclosed manual imaging system comprising a spinning filter wheel/Bayer embodiment with a first NIR comprising a first NIR/red bandpass from about 750 to 1300 nm and a second first NIR/red bandpass from about 630-770 nm, and a third reference bandpass comprising a 550-650 nm bandpass. Band color assignments for the first to third bandpasses were to blue, red and green, so that disturbed ground regions appeared red/blue in the image. Processing used was normalization of bands to emphasize the red/blue. This embodiment has found to be helpful for identifying disturbed ground from sands with vegetation and aged disturbance backgrounds.

FIG. 4D shows bandpass ranges used in an example disclosed manual imaging system comprising a spinning filter wheel/Bayer embodiment with a first NIR/red bandpass from about 580 to 770 nm, a second reference bandpass from about 480 to 630 nm, and a third reference bandpass comprising a 350 to 550 nm bandpass. Band color assignments for the first to third bandpasses used were to red, green and blue, so that disturbed ground regions appeared red. The processing used was decorrelation stretching. This embodiment has found to be helpful for identifying disturbed ground from shale in sand with vegetation and gravel with vegetation backgrounds.

FIG. 4E shows bandpass ranges including a polarizer for daytime imaging and a halogen lamp for night time imaging used in an example disclosed manual imaging system comprising a spinning filter wheel/Bayer embodiment with a first NIR/red comprising a 580 to 1300 nm bandpass with a polarizer, a second reference bandpass 480 to 630 nm, and a third reference bandpass comprising a 350 to 550 nm bandpass. As noted above, when the light source is forward (e.g., from a specular surface) a polarizing filter can be used to ensure the disturbed ground region generally reflects more NIR light back to the camera than the undisturbed ground regions. Band color assignments for the first to third bandpasses used were to red, green and blue, so that disturbed ground regions appeared bright (black & white) B&W in an image. The processing used was normalization of bands to produce a B&W image. This embodiment has found to be helpful for identifying disturbed ground from sand with tire tracks in the background.

FIG. 4F shows bandpass ranges from a disclosed manual imaging system comprising a modified full spectrum color camera (with the hot mirror removed) embodiment with an external band reject filter for blocking 450 nm to 630 nm light for stopping green light. The bands shown are provided by the camera and provide a significant amplitude for the red pixels in the NIR so that disturbed ground appear red/green (yellow) in an image. The processing used was decorrelation stretching. This embodiment has found to be helpful for identifying disturbed ground from clays with vegetation and loams with vegetation backgrounds.

FIG. 4G shows bandpass ranges from an example disclosed manual imaging system comprising a modified full spectrum color camera (with the hot mirror removed) embodiment with a first external band pass from 450 to 630 nm and a second external band pass from 750 to 1300 nm. The bands shown are provided by the camera and provide a significant amplitude for the red pixels in the NIR so that disturbed ground appeared red/green (yellow) in the rendered image. The processing used was normalization of bands. This embodiment has found to be helpful for identifying disturbed ground from gravel with vegetation and loams with vegetation backgrounds.

FIG. 4H shows bandpass ranges from an example disclosed manual imaging system comprising a modified full spectrum color camera (hot mirror removed) embodiment with an external long pass filter having an edge between 530 nm and 580 nm. The bands shown are provided by the camera and were found to provide a significant amplitude for the red pixels in the NIR so that disturbed ground appeared red/blue in the image. The processing used was decorrelation stretching. This embodiment has been found to be helpful for identifying disturbed ground from sands with vegetation and aged disturbance backgrounds.

FIG. 4I shows bandpass ranges from an example disclosed manual imaging system comprising a modified full spectrum color camera (hot mirror removed) embodiment with an external bandpass filter having a passband from about 350 nm to 770 nm. The processing used was decorrelation stretching. This embodiment has found to be helpful for identifying disturbed ground from sands with vegetation and aged disturbance backgrounds.

FIG. 4J shows bandpass ranges from an example disclosed manual imaging system comprising a modified full spectrum color camera (hot mirror removed) embodiment with a broadband external polarizer. The bands shown are provided by the camera were found to provide a significant amplitude for the red pixels in the NIR so that disturbed ground appeared bright B&W in the images obtained. The processing used was normalization of bands to produce a B&W image. This embodiment has found to be helpful for identifying disturbed ground from sands with track backgrounds.

### Normalization and Orthogonalization

Color and channel orthogonalization can comprise finding the eigenfunctions of the color channels and transforming the data to the eigenspace (orthogonal space). The eigenspace can be computed from the covariance of the scene pixels in each of the three (3) color channels for a three color channel detector. Using the sampled pixels, nine sums are needed to calculate the covariance matrix for the three channels. These sums are:

For l=1,3 (three color channels); m=1,l, and sampling n pixels,

$${SUMX}_{l , m} = {\sum }_{k = 1}^{n} {P}_{k , l}^{*} {P}_{k , m}$$

$${SUM}_{l} = {\sum }_{k = 1}^{n} {P}_{k , l}$$

where Pk,l is the value of the kth pixel for Channel l. The covariance matrix is computed, using the following formulas:

$${Cov}_{l , m} = \frac{1}{n - 1} ⌊ {SUMX}_{l , m} - \frac{1}{n} * {SUM}_{l} * {SUM}_{m} ⌋$$

The eigenvectors and eigenvalues of the system described by the covariance matrix are then computed. The matrix of eigenvectors is referred to as the rotation matrix, R, in subsequent steps. The “stretching vector” (or Normalization vector), s, is formed by taking the reciprocal of the square root of each element in the eigenvalue vector, and multiplying it by the desired standard deviation for the output image channels. For true Normalization, the desired standard deviation would be one, but in order to yield output values in the appropriate range for eight bit pixels (i.e., byte data) a higher target value is used. Currently the target standard deviation is set to 50. The final transformation matrix, T, is composed from the rotation matrix and the stretching vector. This is done by the following matrix multiplication:

T=R^{t}sR

Prior to doing the transformation upon the image, this transformation is applied to a vector of the means of the input channels. The result is used to compute the offsets needed to reposition the output image values to the 0 to 255 dynamic range of eight bit data. For each pixel in the scene, the output pixel vector (3 valued) is computed by applying the final transformation matrix, and then the offset vector.

### Band Assignment

As disclosed above, band assignments are generally arbitrary. Thus, band assignment is more about producing a pleasing image than data processing. Different optical filters used make for imagery of a given scene having different appearances. A goal of assigning data to different color bands can be to maintain some level of consistent appearance among the different optical filters.

The following is an Example of an band assignments that have been used to generate a visible image of a scene. Several different external filters were used over a the Bayer filter pattern provided by a convention digital color camera modified (i.e., hot filter removed) to provide full spectrum imaging. In the topmost embodiment, an external Schott OG570 or equivalent filter (passes wavelengths ≧560 nm) was used. In this embodiment, NIR light is assigned to the blue channel, orange/NIR light to the green channel, and red light to the red channel.

| Equivalent Filter | Blue Channel | Green Channel | Red Channel |
|---|---|---|---|
| Schott OG570 | NIR | Orange/NIR | Red |
| Schott BG-3 | UV/Blue | Green/NIR | NIR |
| Green/NIR | NIR | Green | NIR |

While various disclosed embodiments have been described above, it should be understood that they have been presented by way of example only, and not as a limitation. Numerous changes to the disclosed embodiments can be made in accordance with the Disclosure herein without departing from the spirit or scope of this Disclosure. Thus, the breadth and scope of this Disclosure should not be limited by any of the above-described embodiments. Rather, the scope of this Disclosure should be defined in accordance with the following claims and their equivalents.

Although disclosed embodiments have been illustrated and described with respect to one or more implementations, equivalent alterations and modifications will occur to others skilled in the art upon the reading and understanding of this specification and the annexed drawings. While a particular feature may have been disclosed with respect to only one of several implementations, such a feature may be combined with one or more other features of the other implementations as may be desired and advantageous for any given or particular application.

The terminology used herein is for the purpose of describing particular embodiments only and is not intended to be limiting to this Disclosure. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.” Unless otherwise defined, all terms (including technical and scientific terms) used herein have the same meaning as commonly understood by one of ordinary skill in the art to which this Disclosure belongs. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

We claim:

1. A multispectral imaging system for identifying disturbed ground regions, comprising:
an image sensor for receiving diffusely scattered light from an interrogation area, said image sensor comprising:
a 2-D photodetector array that comprises a plurality of photodetector pixels;
at least one filter that transmits a first non-NIR comprising reference band and an NIR comprising band from said diffusely scattered light that is optically coupled to said 2-D photodetector array, wherein said 2-D photodetector array is sensitive to light in both said non-NIR comprising reference band and said NIR comprising band,
wherein said 2-D photodetector array generates separately detected first non-NIR reference band data and NIR comprising band data, and
a processor for data processing coupled to an output of said 2-D photodetector array that separately receives said first non-NIR comprising reference band data and said NIR comprising band data, wherein said data processing comprises utilizing both said NIR band data and said first non-NIR reference band data to generate processed image data.

2. The system of claim 1, wherein said at least one filter comprises a first filter that transmits said first non-NIR comprising reference band and a second filter that transmits said NIR comprising band.

3. The system of claim 1, further comprising:
a third filter that transmits a second non-NIR comprising reference band different from said first non-NIR comprising reference band from said diffusely scattered light that is optically coupled to said photodetector pixels of said 2-D photodetector array that are sensitive to light in said second non-NIR comprising reference band to generate second reference band data,
wherein said data processing further comprises utilizing said second reference band data to generate said processed image data.

4. The system of claim 1, wherein said utilizing comprises ratioing, and said processed image data comprises multi-band image data, further comprising a video display coupled to an output of said processor that generates a displayed image based on said multi-band image data.

5. The system of claim 1, wherein said utilizing further comprises data normalization, color orthogonalization and RGB assignment of said first non-NIR comprising reference band data and said NIR comprising band data.

6. The system of claim 1, wherein said first non-NIR comprising reference band includes ultraviolet (UV) light.

7. The system of claim 1, wherein said processor includes an associated memory that stores at least one of reference measure selected from relative NIR signal level thresholds or ranges, statistics on counts from said 2-D photodetector array, and shapes of detected patterns, wherein said utilizing comprises using said reference measure to automatically identify disturbed ground regions within said interrogation area based on said processed image data.

8. The system of claim 7, wherein said system further comprises an alarm that is activated if said disturbed ground regions are identified.

9. The system of claim 1, wherein said system further comprises a scanner mechanically coupled said imaging system for scanning a field of view of said imaging system across a plurality of different surface portions within said interrogation region.

10. A method for identifying disturbed ground regions, comprising:
receiving diffusely scattered light from an interrogation area;
transmitting a first non-NIR comprising reference band and an NIR comprising band from said diffusely scattered light to a 2-D photodetector array, wherein said 2-D photodetector array generates separately detected first non-NIR reference band data and NIR comprising band data, and
utilizing both said NIR comprising band data to said first non NIR reference band data to generate processed image data, and
identifying disturbed ground regions within said interrogation area using said processed image data.

11. The method of claim 10, further comprising:
transmitting a second non-NIR comprising reference band different from said first non-NIR comprising reference band from said diffusely scattered light to generate second reference band data,
wherein said data processing further comprises utilizing said second reference band data to generate said processed image data.

12. The method of claim 10, wherein said utilizing comprises ratioing, and said processed image data comprises multi-band image data, further comprising generating a displayed image based on said multi-band image data.

13. The method of claim 10, wherein said utilizing further comprises data normalization, color orthogonalization and RGB assignment of said first non-NIR comprising reference band data and said NIR comprising band data.

14. The method of claim 10, wherein said first non-NIR comprising reference band includes ultraviolet (UV) light.

15. The method of claim 10, wherein said identifying disturbed ground regions comprises automatically identifying disturbed ground regions, and said utilizing comprises using at least one reference measure selected from relative NIR signal level thresholds or ranges, statistical measures on counts from said 2-D photodetector array, and shapes of detected patterns for said automatically identifying disturbed ground regions.

16. The method of claim 15, further comprising triggering an alarm if said disturbed ground regions are identified.

17. The method of claim 10, further comprising scanning a field of view to identifying disturbed ground regions for different surface portions within said interrogation region.

18. The method of claim 10, wherein an image sensor used for said method is sensitive to light in a wavelength range from 350 nm to 1,000 nm.
